(19) United States
(12) Patent Application Publication
(10) Pub. No.: US 2010/0188329 A1
(43) Pub. Date: Jul. 29, 2010

(54) PUSH BUTTON SWITCH DEVICE WITH AN OLED DISPLAY

(75) Inventors: Miguel Angel LORENZO RIERA, Sant Climent de Llobregat (ES); Juan José Verdu Martinez, Sant Climent de Llobregat (ES)

Correspondence Address: RATNERPRESTIA, P.O. BOX 980, VALLEY FORGE, PA, 19482, US

(73) Assignee: INDUSTRIAS LORENZO, S.A., Sant Climent de Llobregat (ES)

(21) Appl. No.: 12/692,734

(22) Filed: Jan. 25, 2010

(30) Foreign Application Priority Data
Jan. 27, 2009 (ES) U200900149

(51) Int. Cl. G09G 5/00

(52) U.S. Cl. 345/156

(57) ABSTRACT

A push button switch device with an OLED display includes a support casing for a switch, an actuating member movably assembled in the casing so as to actuate the switch, and a display assembled at an operating end of the actuating member viewable from the outside. The display is programmable so as to display images and is formed by an assembly of organic light emitting diodes, or OLEDs. The device furthermore includes a local control unit with a memory storing predetermined images and/or portions of video. The local control unit includes a field-programmable gate array, or FPGA, connected to the memory and to the display so as to control the selective switching on/off of the OLEDs and to thus display in the display at least part of the images and/or portions of video according to a certain sequence.

### TECHNICAL FIELD

The present invention generally relates to a push button switch device with an OLED display associated with the surface for acting on the push button, of the type comprising a local control unit so as to control the selective switching on/off of said OLEDs, and particularly to a switch device in which said local control unit comprises a field-programmable gate array, or FPGA.

### STATE OF THE PRIOR ART

Patent ES-A-2303666, which is the validation of patent EP-A-1589551, discloses a push button switch assembly with an OLED display supported in a housing thereof in a position to be viewable by a user, and a controller circuit electrically coupled to the switch assembly so as to control the display in response to operation of the switch of the push button switch assembly, and to other factors, such as the passage of a certain period of time. Said controller circuit comprises a power supply, a display driver and a microcontroller responsible for input/output, display driver management, and display update functions, and includes a memory (e.g., flash or RAM). The controller circuit is programmed to cause the OLED display to display certain visual information.

In addition, utility model ES1064635U, belonging to the present applicant, discloses an arrangement of push button switch assemblies, of the type having respective OLED displays with corresponding local control units connected to a central electronic control system through a single common two-way communication bus.

Neither of said patent documents mentioned contemplates the possibility of using another type of local electronic control device that is not a microcontroller.

### DISCLOSURE OF THE INVENTION

The present invention relates to a push button switch device with an OLED display, including:

a switch;
a support casing for said switch;
an actuating member for actuating said switch movably assembled in the mentioned casing;
a display associated with said actuating member, located at an operating end thereof, viewable from the outside, said display being programmable so as to display one or more images and being formed by an assembly of organic light emitting diodes, or OLEDs, and
a respective local control unit with one or more memories, adapted for controlling the selective switching on/off of said OLEDs so as to display said image or images.

Unlike conventional push button switch devices with an OLED display, in the device proposed by the present invention said memory stores a series of predetermined images and/or portions of video, intended for being displayed to increase the appeal (lure function) or in combination with the operation of a machine in which the push button device is installed and said local control unit comprises a field-programmable gate array, commonly known as FPGA, connected to said memory and said display so as to display, by means of said selective switching on/off of the OLEDs, in the display at least part of said images and/or portions of video according to a certain sequence.

To modify said certain sequence and/or to select the images and/or portions of video to be displayed, the FPGA included in the switch device proposed by the present invention is reconfigurable for such purpose.

In one embodiment, the local control unit comprises one or more communication modules connected to the FPGA so as to receive from a remote control unit an index of images and/or portions of video to be displayed, and if desired, to also modify said certain sequence.

Said communication module is a USB, RS232, RS-485 or RS-422 module, depending on the embodiment, being valid a communication module capable of performing basic communication functions that do not require a large data stream or high speed.

In one embodiment, said memory is a NAND flash memory.

### BRIEF DESCRIPTION OF THE DRAWINGS

The foregoing and other advantages and features will be more fully understand from the following detailed description of exemplary embodiments with reference to the attached drawings, which must be interpreted by way of non-limiting illustration, in which:

FIG. 1 is a plan view of a printed circuit board which integrates circuitry including a local control unit for one exemplary embodiment of the invention, and

FIG. 2 is a perspective view of a push button switch assembly proposed by the invention for one exemplary embodiment.

### DETAILED DESCRIPTION OF EXEMPLARY EMBODIMENTS

FIG. 2 shows the push button switch assembly with an OLED display proposed by the present invention for one exemplary embodiment, in which it can be seen how it comprises:

a switch 7;

a support casing 6 for said switch 7;

an actuating member 8 for actuating said switch 7, with a translucent or transparent cover 9, assembled such that it can shift linearly in said casing 6 and adapted to be pushed to operate said switch 7 with an end portion 12 of said actuating member 8;

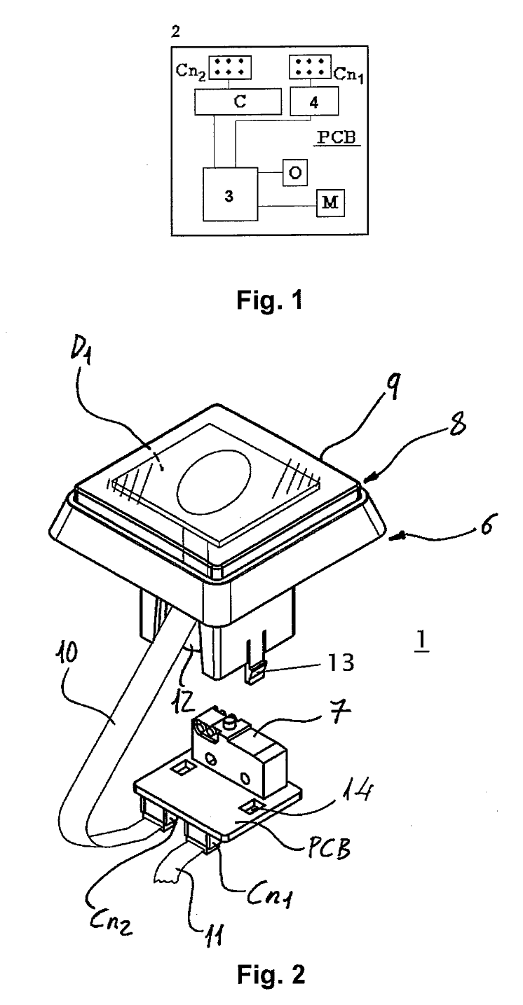

a PCB support board, such as the one shown in FIG. 1, which has a circuit including the local control unit 2 shown in FIG. 1 for one embodiment, said switch 7, and first and second connectors Cn₁, Cn₂, said PCB support board being adapted to be positioned with respect to said casing 6 and fixed thereto for example through tabs 13 and grooves 14 shown in FIG. 2; and

an OLED display D1 associated with said actuating member 8 at an operating end thereof, viewable from the outside through said cover 9, said display D1 being programmable so as to display one or more images and being formed by an assembly of organic light emitting diodes, or OLEDs, and said display D1 being connected with the local control unit 2 through a first wiring 10 connected to said second connector Cn₂, and arranged under said cover 9 of said actuating member 8.

The mentioned first connector Cn₁ is adapted to connect the communication module 4, by means of a second wiring 11, to a device or remote control unit to enable the FPGA 3 to receive said index of images and/or portions of video to be displayed.

FIG. 1 shows the local control unit 2 on the PCB support board, where it can be seen how the control unit 2 includes a memory M connected to an FPGA 3.

In said FIG. 1, another series of elements included in the shown local control unit 2 can be seen, wherein the control unit 2 is formed by the mentioned FPGA 3 connected to an oscillator O, to the memory M, to said communication module 4 connected to said first connector Cn₁, and to a display driver C, connected to a second connector Cn₂ to be connected to the OLED display D₁.

Depending on the embodiment, the FPGA 3 causes a series of images and/or portions of video to be displayed in the display D1 in response to the operation of the switch device 1 by a user or automatically.

In another embodiment (not shown) that is an alternative to that shown in FIG. 2, the FPGA 3, the memory M and the communication module 4 are integrated in an assembly that is associated with a cavity defined at the end of the actuating member 8, protected by a transparent cover 9, instead of being in the PCB support board of FIG. 2

In a preferred embodiment, the push button switch device proposed by the present invention is coupled to a panel of a machine, for example an entertainment machine, for the purpose of performing one or more functions related to said machine when it is pressed by a user.

A person skilled in the art will be able to introduce changes and modifications in the described embodiments without departing from the scope of the invention as it is defined in the attached claims.

1. A push button switch device with an OLED display, said push button switch comprising:
a switch;
a support casing for said switch;
an actuating member for actuating said switch movably assembled in the casing;
a display associated with said actuating member at an operating end thereof, viewable from the outside, said display being programmable so as to display at least one image and being formed by an assembly of organic light emitting diodes (OLEDs), and
a respective local control unit, with at least one memory, adapted for controlling the selective switching on/off of said OLEDs so as to display at least said image;
wherein said memory stores a series of predetermined images and/or portions of video, and said local control unit comprises a field-programmable gate array (FPGA) connected to said memory and to said display so as to display, by said selective switching on/off of the OLEDs, in the display at least part of said images and/or portions of video according to a predetermined sequence.

2. The device according to claim 1, wherein said FPGA is reconfigurable so as to modify said predetermined sequence and/or to select the images and/or portions of video to be displayed.

3. The device according to claim 2, wherein said local control unit comprises at least one communication module connected to said FPGA, so as to receive from a remote control unit at least one index of images and/or portions of video to be displayed.

4. The device according to claim 3, wherein said at least one communication module is a USB, RS232, RS-485 or RS-422 module.

5. The device according to claim 1, wherein said memory is a NAND flash memory.

6. The device according to claim 2, wherein said memory is a NAND flash memory.

7. The device according to claim 3, wherein said memory is a NAND flash memory.

8. The device according to claim 4, wherein said memory is a NAND flash memory.
